(19) United States
(12) Patent Application Publication
(10) Pub. No.: US 2008/0169799 A1
(43) Pub. Date: Jul. 17, 2008

(54) Method for biosensor analysis

(76) Inventors: Shiow-Chen Wang, Chu-Nan (TW); Wen-Hai Tsai, Chu-Nan (TW); Ying-Shiue Jeng, Chu-Nan (TW); Tsai-Yi Chen, Chu-Nan (TW); Jih-Hsin Yeh, Chu-Nan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/652,579

(22) Filed: Jan. 12, 2007

(51) Int. Cl. G01N 27/00

(52) U.S. Cl. 324/71.1

(57) ABSTRACT

In a method for biosensor analysis, a sample is tested in multiple stages using a biosensor and a test chip thereof to enable easy and convenient handling of the biosensor and accurate analyte measurement with the biosensor. The test chip of the biosensor has specially designed biochemical reaction zone, in which immobilized enzymes and high-molecular bonding agent are applied, so that even a very small liquid sample may be quickly introduced into and absorbed at the biochemical reaction zone to biochemically react with the enzymes on the test chip. With the multi-stage testing method and electronic circuits of the biosensor for logic determination, the biosensor may have increased accuracy.

### FIELD OF THE INVENTION

The present invention relates to a method for biosensor analysis, and more particularly to a method for testing a liquid sample in multiple stages in a convenient, easy, and accurate manner by using a biosensor and a test chip thereof.

### BACKGROUND OF THE INVENTION

A biosensor includes a biochemical identifying element and an electronic signal converter. When a particular analyte in the sample is identified by the identifying element, a chemical signal is converted by the electronic signal converter into an electronic physical signal, which is analyzed through a series of logic operations, so that a quantized digital signal is converted into a concentration of the analyte and output directly.

Most of the currently commercially available electrochemical biosensors are amperometric biosensors, in which a potential applied between a working and a reference electrode is controlled to obtain an electrochemical reaction current of the sample. These amperometric biosensors have been developed for use in detecting blood glucose, cholesterol, and many other drugs.

An amperometric biosensor mainly includes a base plate, a pair of thin-film electrodes, an insulating layer, and an enzymatic biochemical reaction zone. A test chip with a bipolar thin-film electrode refers to a working electrode and a counter electrode. When a sample has been evenly introduced into the biochemical reaction zone to react with enzymes, the sample is oxidized to produce electrons, which are then transferred via the enzymes to an electron transfer mediator. Thereafter, a properly controlled stable voltage is applied between the two electrodes to initiate the oxidation-reduction reaction for a second time. The stable voltage must be high enough for driving a diffusion-limited electronic oxidation on the surface of the working electrode without causing a reverse chemical reaction. After the stable voltage has been applied to the working electrode for a time period, detection of the produced current, which is referred to as the Cottrell current, is conducted. The current produced in the electrochemical oxidation-reduction reaction is in direct proportion to the concentration of the sample, and may be expressed in the equation below:

$$\begin{matrix} \\ i = {nFAc}_{o} \sqrt{\frac{D}{π t}} \\ \end{matrix}$$

### Where

n is the number of electrons having been transferred;
F is Faraday's constant;
A is the area of the testing electrode;
C₀ is the concentration of the analyte;
D is the diffusion coefficient; and
t is time.

In conventional analysis methods, when the biosensor is applied in testing a blood sample, the blood sample must be pretreated. However, the use of whole blood as sample would be more convenient and time-saving, and it is known the viscosity and the volume of blood sample also have influences on the test results. For some aged patients, there might be only very small volume of whole blood at the finger tip, and it is possible that uneven and/or insufficient blood volume is supplied to the biosensor for testing and thereby causes man-made errors in test. On the other hand, deliquescence occurs in the biochemical reaction zone on a test chip of the biosensor before and after the analyte detection would also cause errors in readings.

Therefore, it is desirable and necessary to develop a simple error detection technique that may be easily employed in small-volume sample testing to avoid incorrect detecting results.

### SUMMARY OF THE INVENTION

A primary object of the present invention is to provide a method for biosensor analysis, so that the biosensor can be more conveniently handled to measure an analyte more accurately.

Another object of the present invention is to provide a method for biosensor analysis, in which a sample is tested in multiple stages using a biosensor and a test chip thereof to increase the accuracy of sample testing.

In the method for biosensor analysis according to the present invention, a sample is tested in multiple stages using a biosensor and a test chip thereof to enable easy and convenient handling of the biosensor and accurate analyte measurement with the biosensor. The test chip of the biosensor has specially designed biochemical reaction zone, in which immobilized enzymes and high-molecular bonding agent are applied, so that even a very small liquid sample may be quickly introduced into and absorbed at the biochemical reaction zone to biochemically react with the enzymes. With the multi-stage testing method and electronic circuits of the biosensor for logic determination, the biosensor may have increased accuracy.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a test chip for a biosensor, with which a sample is tested in the method of the present invention;

FIG. 2 is an assembled view of FIG. 1;

FIG. 3 is a sectional view taken along line 3-3 of FIG. 2;

FIG. 4 is a fragmentary sectional view taken along line 4-4 of FIG. 2;

FIG. 5 is a top view showing the manner in which a dielectric layer is applied over a carbon electrode layer and a silver electrode layer of the test chip of FIG. 2;

FIG. 6 is a block diagram showing the electrical connection between the biosensor and the test chip thereof;

FIG. 7 is a curve diagram showing changes of current at different stages, i.e., when the biosensor is powered on, during biochemical reaction time, and at reaction current sensing; and

FIGS. 8A and 8B show a flowchart of the method for biosensor analysis according to the present invention.

### DETAILED DESCRIPTION OF THE PREFERRED EMBODIMENTS

The present invention provides a method for biosensor analysis, so as to easily detect any errors in a test chip of a biosensor before the biosensor is set to a standby mode, and allow the biosensor to conveniently test a liquid sample as small as 0.5 to 3.5 μl in volume without producing inaccurate testing results. With a specially designed biochemical reaction zone formed on the test chip, and immobilized enzymes and bonding agent applied in the biochemical reaction zone, the method for biosensor analysis according to the present invention also allows the biosensor to accept whole blood as test sample. The liquid sample may be quickly introduced into and absorbed at the biochemical reaction zone to produce a series of biochemical reactions. Moreover, since the method of the present invention provides multi-stage testing and logic determination based on electronic circuits of the biosensor, the biosensor may have increased accuracy.

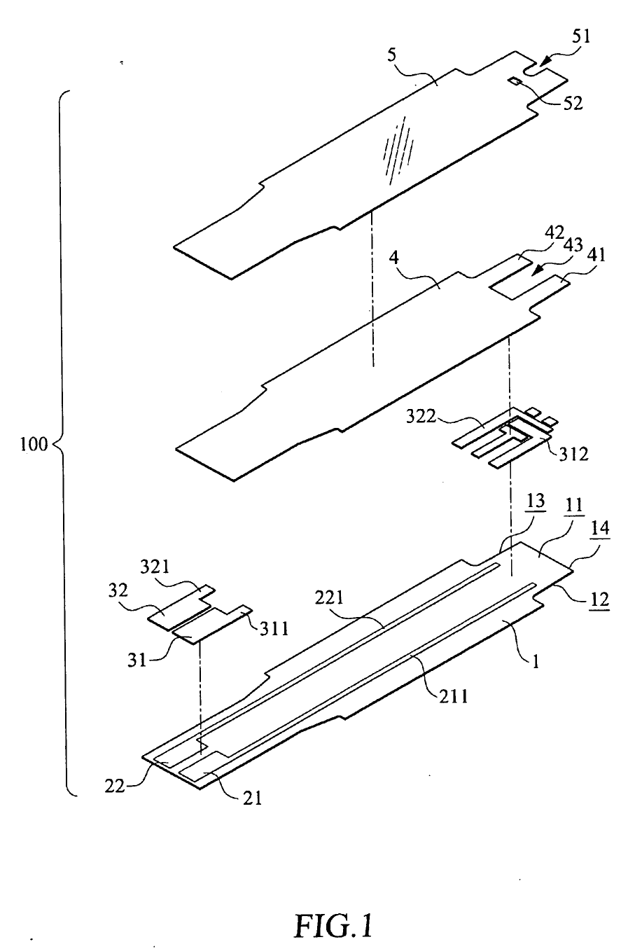

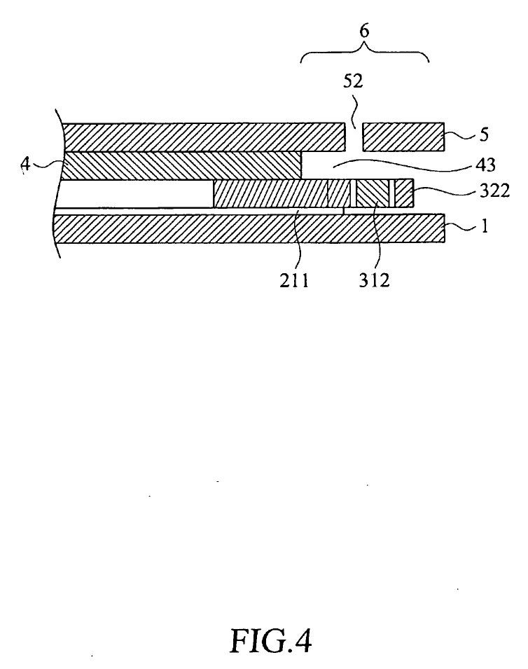

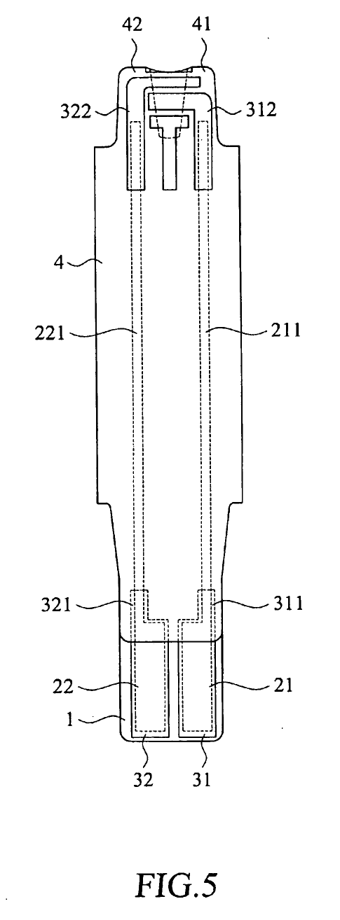

Please refer to FIGS. 1 to 5 that show a test chip 100 for a biosensor, with which a sample is tested in the method of the present invention. As shown, the test chip 100 includes an insulating base plate 1, which forms a base of the test chip 100.

The base plate 1 is made of an insulating and heat-resistant material, which may be any one or any combination of polyvinyl chloride, polyethylene glycol terephthalate, polycarbonate, polyamide, polyester, nylon, and nitrocellulose.

On the base plate 1, there is provided a pair of thin-film electrodes, which may be formed on the base plate 1 by way of a known skill, such as screen printing or sputtering. The pair of thin-film electrodes includes at least a positive and a negative wire, which do not contact with each other and serve as a working electrode 21 and a counter electrode 22, respectively. The working electrode 21 and the counter electrode 22 are made of a material with good electrical conductivity, and may be any one or any combination of carbon ink, silver ink, silver/silver chloride ink, gold, platinum, and palladium. In the illustrated embodiment of the test chip 100, the pair of thin-film electrodes is a silver electrode layer formed of silver ink.

A reaction zone surface 11 is defined at an upper end of the base plate 1. The reaction zone surface 11 is coated with a layer of biochemical reagent to form a biochemical reaction layer. Three edges of the reaction zone surface 11 are separately defined as a first lateral edge 12, a second lateral edge 13, and an end edge 14.

The working electrode 21 has one extended end forming a narrowed extension section 211, which is ended at a point close to the first lateral edge 12 of the reaction zone surface 11. The counter electrode 22 also has an extended end forming a narrowed extension section 221, which is ended at a point close to the second lateral edge 13 of the reaction zone surface 11. The other ends of the working and the counter electrode 21, 22 opposite to the extension sections 211, 221, respectively, together serve as a connection zone for connecting to an electronic signal converter (not shown) of the biosensor.

A first carbon electrode 31 and a second carbon electrode 32 are further formed over the working electrode 21 and the counter electrode 22, respectively. The first and the second carbon electrode 31, 32 respectively have a width and an extending path the same as those of the working and the counter electrode 21, 22, and include an extension section 311, 321 each. The first and the second carbon electrode 31, 32 are provided for covering and thereby preventing the working and the counter electrode 21, 22, respectively, from surface oxidation.

A first reaction electrode 312 and a second reaction electrode 322 are provided on the reaction zone surface 11 of the base plate 1 opposite to the extension sections 311, 321 of the first and the second carbon electrode 31, 32, respectively. Since the first and the second reaction electrode 312, 322 are spaced from the extension sections 311, 321 of the first and second carbon electrodes 31, 32 by a predetermined distance without contacting with them, signals generated by the first and the second reaction electrode 312, 322 are transmitted to the working and the counter electrode 21, 22 via the extension sections 211, 221 thereof.

The first and second carbon electrodes 31, 32 and the extension sections 311, 321 thereof, as well as the first and second reaction electrodes 312, 322 are collectively referred to as a carbon electrode layer herein.

A dielectric layer 4 is further provided to overlap the carbon electrode layer and the base plate 1. The dielectric layer 4 includes a pair of spacers 41, 42, which are located above the reaction zone surface 11 of the base plate 1 and together define a convection clearance 43 between them. The dielectric layer 4 covers only part of the first and second carbon electrodes 31, 32 and the base plate 1, and does not fully cover the reaction zone surface 11 of the base plate 1 to thereby partially expose the first and second reaction electrodes 312, 322.

The dielectric layer 4 functions to protect the electrodes, and has a predetermined thickness to thereby allow the forming of a three-dimensional biochemical reaction zone 6, which will be described in more details later. With the three-dimensional structure, the sample may be advantageously quickly introduced via a biochemical reaction layer, which will be described in more details later, into the biochemical reaction zone 6 and be absorbed thereat. The thickness of the dielectric layer 4 is within the range from 0.01 to 0.10 mm.

The thickness of the dielectric layer 4 determines the size of the biochemical reaction zone 6 and the required reaction volume of sample. A uniform thickness may be obtained for the dielectric layer 4 by selecting a proper insulating material and applying the selected insulating material over the base plate 1 and the carbon electrode layer using stainless steel screen printing technique.

The insulating material for the dielectric layer 4 may be selected from the group consisting of acrylate, vinyl polyester, polyamide, epoxy resin, polyvinylchloride, polyethylene glycol terephthalate, polycarbonate, and polyester.

Finally, an upper lamina 5 is bonded to a top of the dielectric layer 4. A portion of the upper lamina 5 corresponding to the end edge 14 of the base plate 1 is formed with a sample dripping notch 51, via which the sample is dripped, and another portion of the upper lamina 5 located above the convection clearance 43 of the dielectric layer 4 is formed with a convection hole 52, so that sample dripped via the notch 51 may flow to the biochemical reaction zone 6.

In a preferred embodiment of the test chip 100, a portion of the upper lamina 5 located above the biochemical reaction zone 6 is transparent to serve as an inspection window, via which a user may conveniently check whether the sample has completely introduced into the biochemical reaction zone 6. The upper lamina 5 may be made of a material selected from any one or any combination of polyvinylchloride, polyethylene glycol terephthalate, polycarbonate, polyamide, polyester, and nitrocellulose.

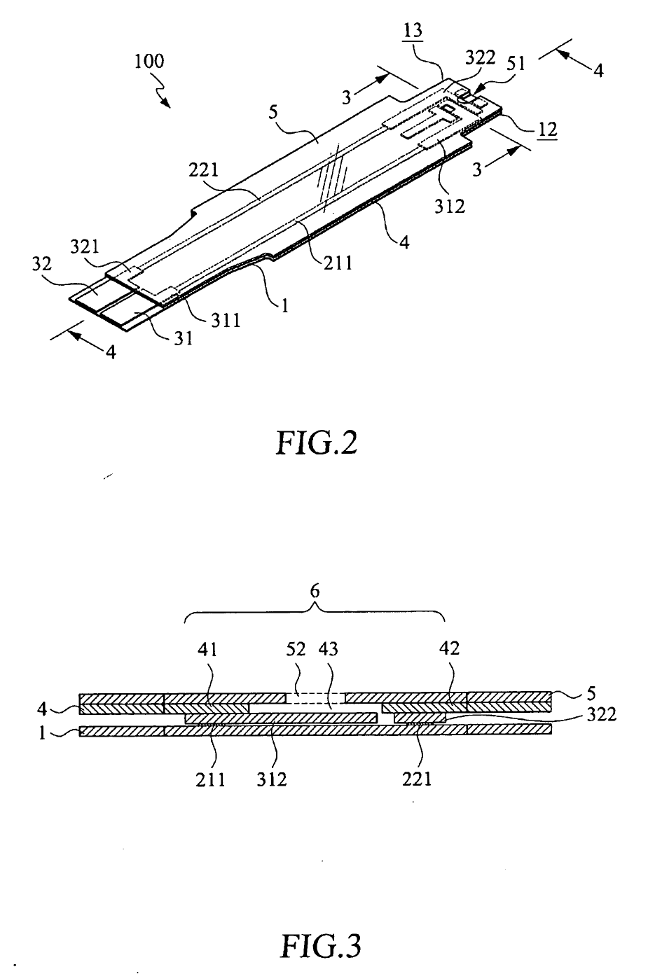

Please refer to FIGS. 2, 3, and 4. In a fully assembled test chip 100, an exposed front end of the pair of thin-film electrodes, i.e. the working and the counter electrodes 21, 22, within the reaction zone surface 11 on the base plate 1, the dielectric layer 4 having a predetermined thickness, and the upper lamina 5 together constitute a three-dimensional space that serves as the above-mentioned biochemical reaction zone 6.

The reaction zone surface 11 is coated with a layer of biochemical reaction reagent to serve as the above-mentioned biochemical reaction layer. In addition to play an important role in enzymatic reaction, the biochemical reaction layer also includes hydrophilic high-molecular bonding agent that has initiation function to introduce the sample into the biochemical reaction zone 6. The convection clearance 43 in the biochemical reaction zone 6 further enables the sample to be more quickly introduced into and absorbed at the biochemical reaction zone 6 to produce a series of biochemical reactions. The biochemical reaction layer consists of different reagents, including a buffer solution, biochemical reaction enzymes, an electron transfer mediator, a high molecular bonding agent, and a surfactant. The biochemical reaction zone 6 provides a space small enough to be completely filled by 0.5 to 3.5 μl of sample.

Moreover, the working electrode 21 and the counter electrode 22 are so printed on the base plate 1 that they are different in length in the biochemical reaction zone 6. This design ensures the sample introduced into the biochemical reaction zone 6 to be measured at the same reaction initiation time. When the sample is introduced into the biochemical reaction zone 6 by the hydrophilic high molecules in the biochemical reaction layer under an effect of the convection clearance 43 on the dielectric layer 4, the sample would first contact with the working electrode 21. However, the biochemical reaction time is counted from when the sample reaches the counter electrode 22, so as to increase the test stability.

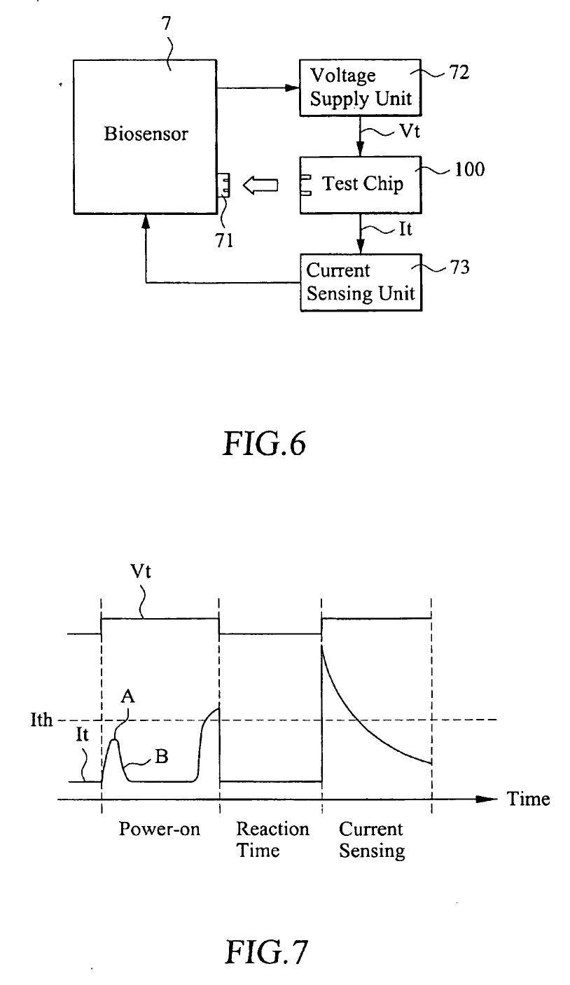

FIG. 6 is a block diagram showing an electrical connection between the test chip 100 and a biosensor 7. The test chip 100 may be plugged at a front end, i.e. an end with the front ends of the first and the second carbon electrodes 31, 32, into a preformed conducting socket 71 on the biosensor 7, such that the biosensor 7 may supply a test voltage Vt via a voltage supply unit 72 to the test chip 100, and senses the current condition It at the test chip 100 via a current sensing unit 73.

The method of the present invention for biosensor analysis first detects any errors in the above-described biosensor 7 and test chip 100 before the biosensor 7 is set to a standby mode, and then tests a sample and makes logic determination in multiple stages, so as to protect consumers against incorrect testing results.

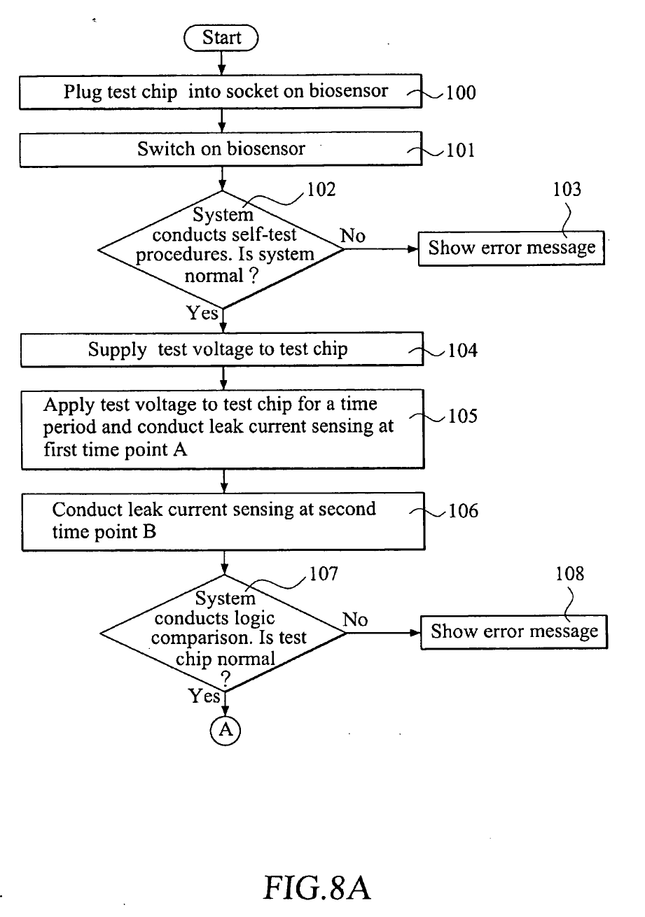

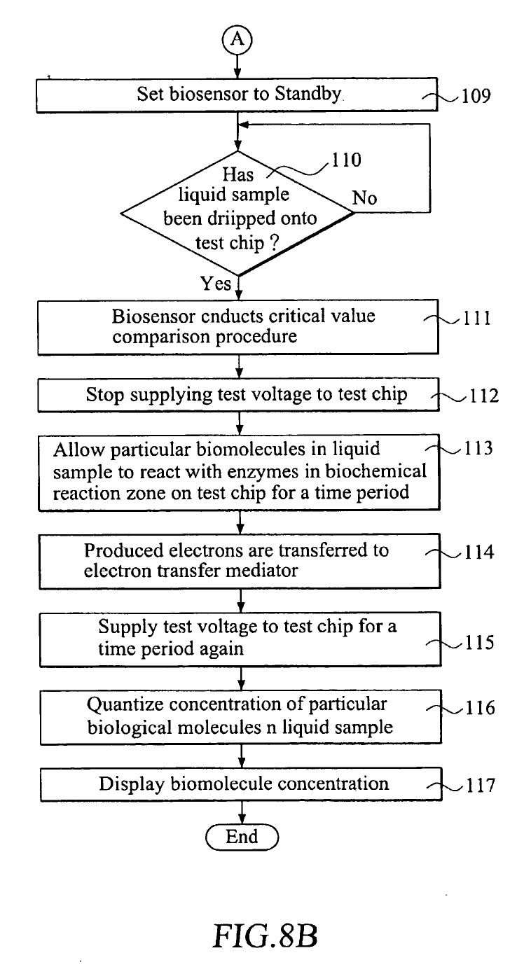

FIG. 7 is a curve diagram showing changes of current at different test stages, i.e., the stage of powering on the biosensor 7, the stage of biochemical reaction time, and the stage of reaction current sensing. And, FIGS. 8A and 8B show a flowchart of the method for biosensor analysis according to the present invention.

To conduct a biosensor analysis in the method of the present invention, first plug one test chip 100 into the conducting socket 71 on the biosensor 7 (Step 100), and then switch on the biosensor 7 (Step 101). At this point, the biosensor would proceed with a series of system self-test procedures to determine whether the biosensor is in a normal condition or not (Step 102). When the biosensor is determined as abnormal in the system self-test procedures, an error message is shown (Step 103). On the other hand, when the biosensor is determined as normal in the system self-test procedures, a test voltage Vt would be supplied by the biosensor 7 via the voltage supply unit 72 to the test chip 100 (Step 104).

Then, testing procedures would be conducted to test the test chip 100, so as to find out changes of current in different reaction modes. The testing procedures include a leak current sensing at a first test time point A when the test voltage Vt has been applied to the test chip 100 for a predetermined time period (Step 105), and another leak current sensing at a second test time point B (Step 106).

When the testing procedures for the test chip 100 are completed, the biosensor 7 conducts an algorithm, and the biosensor system conducts a logic comparison to determine whether the test chip 100 is in a normal condition or not (Step 107). More specifically, values of sensed leak current are logically compared with a current parameter value built in the biosensor system, so that the biosensor 7 may determine the exact condition of the test chip 100. Wherein, the built-in current parameter value does not exceed 10 μA.

When the test chip 100 is determined as abnormal from the logic comparison, an error message indicating an abnormal test chip for the biosensor 7 is shown to remind the operator (Step 108). And, when the test chip 100 is determined as normal from the logic comparison, the biosensor 7 is set to standby (Step 109). The first and the second test time point A, B for leak current sensing are set to about 0 to 10 seconds after the biosensor 7 is powered on, so as to minimize possible interference and ensure the stability of the test chip 100. More specifically, the first test time point A is set to 0 second after the biosensor 7 is started, and the second test time point B is set to up to 10 seconds after the biosensor 7 is started. The values of the leak current sensed at the first and the second test time point A, B should not exceed the built-in current parameter value.

When a liquid sample is dripped into the sample dripping notch 51 on the test chip 100 (Step 110), it is introduced by the high-molecular bonding agent in the biochemical reaction layer on the test chip 100 and helped by the convection clearance 43 and convection hole 52 in the biochemical reaction zone 6 to quickly flow into and be absorbed at the biochemical reaction zone 6. At this point, the biosensor 7 would conduct a critical value comparison procedure (Step 111) to determine whether the values of the sensed leak current are larger than a threshold current value Ith or not, so as to determine whether the liquid sample subjected to the test is sufficient in volume.

When the sample volume is found acceptable in the critical value comparison procedure, the voltage supply unit 72 of the biosensor 7 stops supplying the test voltage Vt to the test chip 100 (Step 112), and a particular type of biological molecules in the liquid sample is allowed to biochemically react with the enzymes in the biochemical reaction zone 6 on the test chip 100 for a predetermined time period (Step 113).

When the particular type of biological molecules in the liquid sample has reacted with the enzymes in the test chip 100 for the predetermined time period, electrons produced in the biochemical reaction are transferred to an electron transfer mediator (Step 114). Wherein, the transfer of the produced electrons to the electron transfer mediator occurs when the biochemical reaction between the liquid sample and the enzymes in the test chip 100 has occurred for 1 to 10 seconds. Thereafter, the voltage supply unit 72 is caused to supply the test voltage Vt to the test chip 100 for a predetermined time period again (Step 115). At this point, the number of electrons having been transferred to the electron transfer mediator is converted by the electronic signal converter of the biosensor 7 into a quantized biomolecule concentration of the particular type of biological molecules in the tested liquid sample (Step 116). And, the biomolecule concentration is shown on the biosensor 7 (Step 117) to complete the biosensor analysis.

What is claimed is:

1. A method for biosensor analysis, the biosensor including a test chip provided with a biochemical reaction zone, in which a biochemical reaction occurs between a particular type of biological molecules in a liquid sample and reagents in the biochemical reaction zone when the test chip is plugged in and electrically connected to the biosensor, and signals produced in the biochemical reaction being transferred to the biosensor; the method comprising the steps of:
(a) detecting whether a test chip has been correctly plugged in the biosensor;
(b) if yes, switching on the biosensor for the biosensor to supply a test voltage to the test chip;
(c) conducting a leak current sensing procedure on the chip test at a predetermined first time point after the test voltage has been applied to the test chip for a predetermined time period;
(d) setting the biosensor to standby mode when the test chip is determined as normal for use;
(e) causing the biosensor to conduct a critical value comparison procedure when an amount of liquid sample has been dripped onto the test chip via a sample dripping notch thereof;
(f) stopping the supply of the test voltage from the biosensor to the test chip when a satisfied result is obtained from the critical value comparison procedure, and allowing the biochemical reaction between the particular type of biological molecules in the liquid sample and the reagents in the biochemical reaction zone on the test chip to continue for a predetermined time period;
(g) allowing electrons produced in the biochemical reaction occurred in the biochemical reaction zone on the test chip to be transferred to an electron transfer mediator; and
(h) supplying the test voltage to the test chip for a second time, and then quantizing a biomolecule concentration of the particular type of biological molecules in the liquid sample, and showing the biomolecule concentration on the biosensor.

2. The method for biosensor analysis as claimed in claim 1, further comprising a step of conducting a series of system self-test procedures after the step (a), and showing a system error message when an error is found in the system self-test procedures.

3. The method for biosensor analysis as claimed in claim 1, further comprising a step of conducting another leak current sensing procedure on the chip test at a predetermined second time point after the test voltage has been applied to the test chip at the first time point in the step (c).

4. The method for biosensor analysis as claimed in claim 3, wherein the first test time point and the second test time point for conducting the leak current sensing procedures on the test chip are about 0 to 10 seconds after the biosensor is switched on in the step (b).

5. The method for biosensor analysis as claimed in claim 4, wherein the test chip is determined as normal in the leak current sensing procedures conducted on the test chip at the first test time point and the second test time point when values of sensed leak current do not exceed a current parameter value of 10 μA built in the biosensor.
